(19) United States
(12) Patent Application Publication
(10) Pub. No.: US 2008/0227581 A1
(43) Pub. Date: Sep. 18, 2008

(54) Axle housing with differential bearing support

(76) Inventors: Michael J. Catalano, Toledo, OH (US); James A. Krisher, Fort Wayne, IN (US); Thomas L. Nahrwold, Swanton, OH (US)

Correspondence Address: BERENATO, WHITE & STAVISH, 6550 ROCK SPRING DRIVE, SUITE 240, BETHESDA, MD, 20817, US

(21) Appl. No.: 11/716,585

(22) Filed: Mar. 12, 2007

(51) Int. Cl. F16H 48/06; F16H 57/02

(52) U.S. Cl. 475/220; 475/230; 74/606 R

(57) ABSTRACT

An axle assembly for a motor vehicle comprises an axle housing having a central axis and first and second openings formed through the axle housing opposite to each other, a carrier with a differential bearing support supporting a differential thereon for rotation about the central axis, and an abutment member attached to the axle housing adjacent to the first opening to extend substantially in a direction of the central axis. The carrier is fastened to the axle housing adjacent to the second opening therein. The abutment member engages the differential bearing support and absorbs a gear separating force imparted in operation by the differential and transmitted to the differential bearing support. Thus, the abutment member restrains deflection of the differential bearing support relative to the axle housing resulting from the gear separating force.

### BACKGROUND OF THE INVENTION

1. Field of the Invention

This invention relates in general to vehicle axle assemblies and in particular to an axle housing provided for restraining an axial deflection of a differential bearing support.

2. Description of the Prior Art

Axle assemblies are well known structures which are in common use in many motor vehicles. Such axle assemblies include a number of components which are adapted to transmit rotational power from an engine of the vehicle to drive wheels thereof. Typically., an axle assembly comprises a differential mounted to a non-rotating carrier. The differential, in turn, includes a differential mechanism disposed in a differential case which is rotatably supported within the non-rotating carrier. The differential is connected between an input drive shaft extending from the vehicle engine and a pair of output axle shafts extending to the vehicle drive wheels. The axle shafts are contained in respective non-rotating hollow, elongated axle arm sections which are secured to the carrier. Thus, rotation of the differential by the drive shaft causes corresponding rotation of the axle shafts. The carrier and the axle arm sections form an axle housing for these drive train components of the axle assembly, inasmuch as the differential and the axle shafts are supported for rotation therein.

One of the common types of the axle housing, commonly referred to as a banjo-type axle housing, comprises hollow, elongated axle arm sections connected together by a hollow central section which is formed separate and apart from the carrier. This central section is generally hollow and cylindrical in shape, having a large generally circular opening formed therethrough. During assembly, the differential is first mounted to the carrier, then the carrier is secured to the central section of the axle housing. Banjo-type axle housings are advantageous because the carrier and the differential can be removed from the axle assembly for service without disturbing the other components thereof.

As mentioned above, the differential is supported for rotation within the carrier. In a conventional banjo-type axle housing, the differential case is rotatably supported by annular anti-friction bearings which are mounted on bearing supports formed integrally with the carrier. The bearings are assembled and held in position by bearing caps of the bearing supports bolted to the carrier These bearing supports and the bearing caps extend within an interior of the central section of the axle housing.

Because the bearings support the differential case, the bearing supports are subjected to a gear separating force (torque load) created when the axle assembly is operated. The gear separating force can be large enough to deflect the bearing supports, causing undesirable misalignment of differential gears and consequent premature wear. The bearing support of a flange-side differential bearing, i.e. the differential bearing adjacent to a ring gear, experiences especially a large amount of the gear separating force that is resisted or constrained by the carrier and the bearing support. The gear separating force is translated through the differential case as an increased bearing load, which deflects the bearing support (thus the bearing cap) axially away from the pinion gear and the carrier. This decreases the torque capacity and life of hypoid gear sets (final drive) in banjo-type axle assemblies. With known carrier structures, the size of the bearing supports is limited by the available space within the opening of the central section. However, in order to assemble the carrier into the banjo housing, clearance is required between the banjo housing and the differential bearing caps mounted to the carrier. As a result of a clearance necessary to assemble the carrier into the banjo housing, the bearing cap does not have any structural support to resist the deflection of the bearing support under load.

In other words, currently banjo-type axle housings do not support the differential bearing caps. Since they are cantilevered out from the rest of the carrier they have a low spring rate and substantially deflect under load (gear separating force). Thus, the banjo-type axle housings of the prior art are susceptible to improvements that reduces premature wear of a differential and extends the useful life of the axle assembly.

### SUMMARY OF THE INVENTION

The present invention provides an improved axle assembly for a motor vehicle provided for restraining an axial deflection of a differential bearing support and a method for assembling the same.

The axle assembly of the present invention comprises an axle housing having a central axis and first and second openings formed through the axle housing opposite to each other, a carrier with a differential bearing support supporting a differential thereon for rotation about the central axis, and an abutment member attached to the axle housing adjacent to the first opening to extend substantially in a direction of the central axis. The carrier is fastened to the axle housing adjacent to the second opening therein. The abutment member engages the differential bearing support and is axially compressed by a gear separating force imparted in operation on the differential and transmitted to the differential bearing support. Thus, the abutment member restrains deflection of the differential bearing support relative to the axle housing resulting from the gear separating force.

The method for assembling the drive axle assembly of the present invention comprises the steps of providing an axle housing having a central axis and first and second openings formed through the axle housing opposite to each other, attaching an abutment member to the axle housing adjacent to the first opening so as to extend substantially in a plane defined by the first opening, and providing a carrier including a differential bearing support supporting a differential thereon for rotation about the central axis. Then, the carrier is inserted into the axle housing through the second opening. Subsequently, the carrier is moved laterally along the central axis until the differential bearing support engages the abutment member.

Therefore, the present invention provides a novel abutment structure for a differential bearing support in the form of an abutment member attached to an axle housing and oriented in a direction of a gear separating force imparted in operation on the differential so as to engage the bearing support and absorb the gear separating force. Thus, the present invention minimizes or prevents (restraints) deflections of the bearing support and, therefore, holds differential gears in proper positions, and extends the useful life and strength of the axle assembly. The present invention provides an economical means to support the differential bearing support to resist movement while under load.

### BRIEF DESCRIPTION OF THE DRAWINGS

Other objects and advantages of the invention will become apparent from a study of the following specification when viewed in light of the accompanying drawings, wherein:

FIG. 1 is an exploded perspective view a drive axle assembly according to a first exemplary embodiment of the present invention;

FIG. 2 is a partial sectional view of the drive axle assembly according to the first exemplary embodiment of the present invention;

FIG. 3 is a partial cross-sectional view of the drive axle assembly according to the first exemplary embodiment of the present invention taken along a line 3-3 of FIG. 2;

FIG. 4 is a partial cross-sectional view of an axle housing according to the first exemplary embodiment of the present invention taken along a line 3-3 of FIG. 2;

FIG. 5 is a front view of a carrier according to the present invention;

FIG. 6 is a partial sectional view of a drive axle assembly according to a second exemplary embodiment of the present invention;

FIG. 7 is a partial cross-sectional view of the drive axle assembly according to the second exemplary embodiment of the present invention taken along a line 7-7 of FIG. 6;

FIG. 8 is a partial cross-sectional view of an axle housing according to the second exemplary embodiment of the present invention taken along a line 7-7 of FIG. 6.

### DESCRIPTION OF THE PREFERRED EMBODIMENTS

The preferred embodiments of the present invention will now be described with the reference to accompanying drawing.

For purposes of the following description, certain terminology is used in the following description for convenience only and is not limiting. The words such as “front” and “rear”, “left” and “right”, “inboard” and “outboard”, “inwardly” and “outwardly” designate directions in the drawings to which reference is made. The words “smaller” and “larger” refer to relative size of elements of the apparatus of the present invention and designated portions thereof. The terminology includes the words specifically mentioned above, derivatives thereof and words of similar import. Additionally, the word “a”, as used in the claims, means “at least one”.

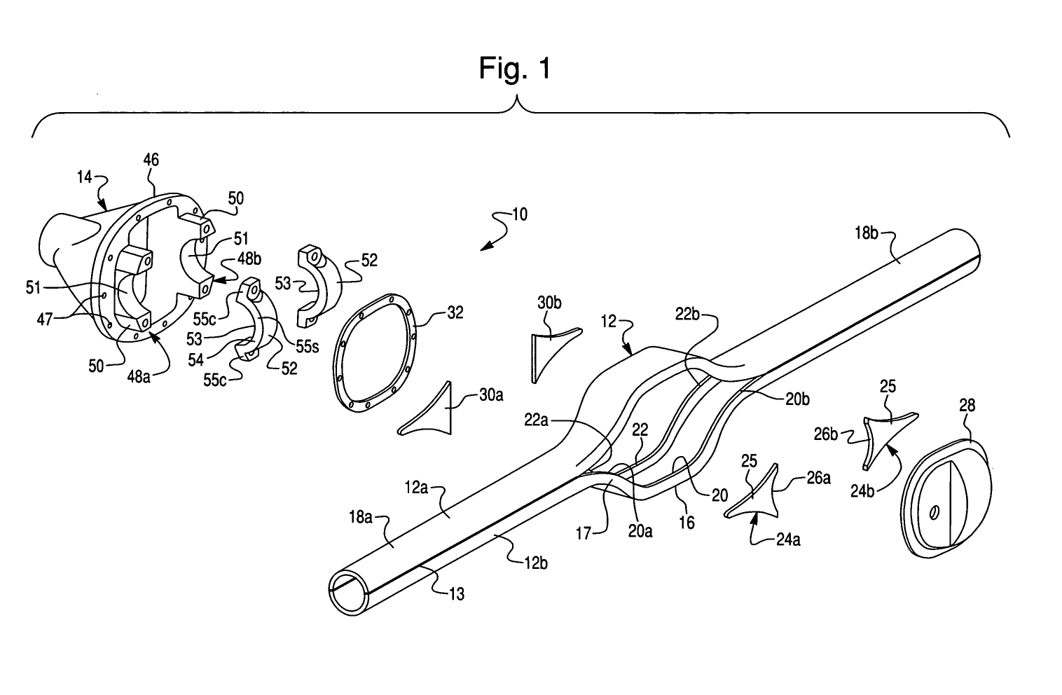

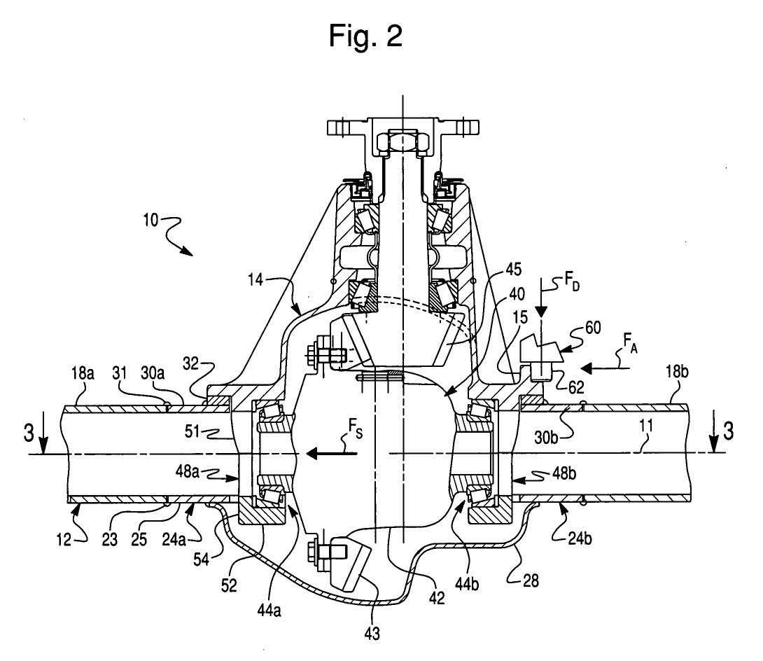

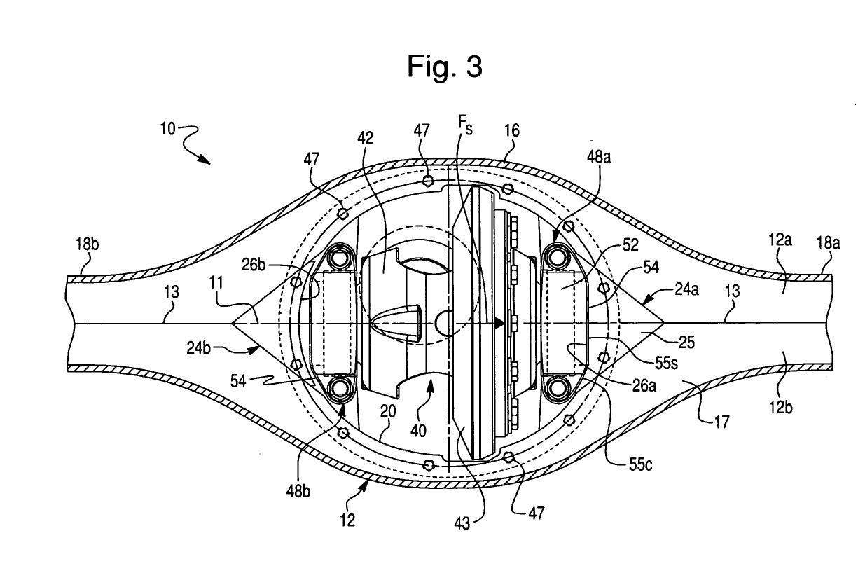

Referring to FIG. 1 of the drawings, a first exemplary embodiment of a drive axle assembly, generally denoted by reference numeral 10, for use in a conventional motor vehicle, is illustrated. The axle assembly 10 includes a banjo-type axle housing, generally denoted by reference numeral 12, and a carrier 14 non-rotatably fastened to the axle housing 12 and rotatably supporting a differential case 42 of a conventional differential 40 through conventional first (left) and second (right) differential bearings 44a and 44b , respectively (shown in FIGS. 2 and 3).

The banjo-type axle housing 12 comprises a hollow central section 16, and first (left) and second (right) hollow, elongated axle arm sections 18a and 18b, respectively, axially extending from the central section 16 in opposite directions along a central longitudinal axis 11 of the axle housing 12. In other words, the hollow central section 16 is formed separate and apart from the carrier 14. The axle housing 12 can be formed by any conventional method known in the art. For example, the axle housing 12 is manufactured by forming complementary first and second elongated axle housing half members 12a and 12b, and permanently joining edges of the first and second housing half members 12a and ]2b by welding as shown at 13 in FIGS. 1, 3 and 4, so as to form the axle housing 12.

The central section 16 defines a hollow interior which is adapted to enclose the carrier 14 rotatably supporting the differential case 42 and a ring gear 43 (shown in FIG. 2) therein. During assembly, the differential 40 is first assembled within (mounted to) the carrier 14, then the carrier 14 is secured to the central section 16 of the axle housing 12. The axle arm sections 18a, 18b extending outwardly from the central section 16 are adapted to enclose respective rotatable axle shafts (not shown) therein. The central section 16 has a first (rear) central opening 20 formed therethrough on its rear side and a second (front) central opening 22 formed therethrough on its front side. The central openings 20 and 22 are generally oval or circular in shape. Each of the central openings 20 and 22 defines a plane oriented substantially along (or parallel to) the central axis 11. The central openings 20 and 22 have substantially large respective first (left) and second (right) triangularly shaped open side portions 20a, 20b and 22a, 22b formed adjacent to the first and second axle arm sections 18a, 18b, respectively. This configuration is typically provided when the central section 16 is formed in the manner described above.

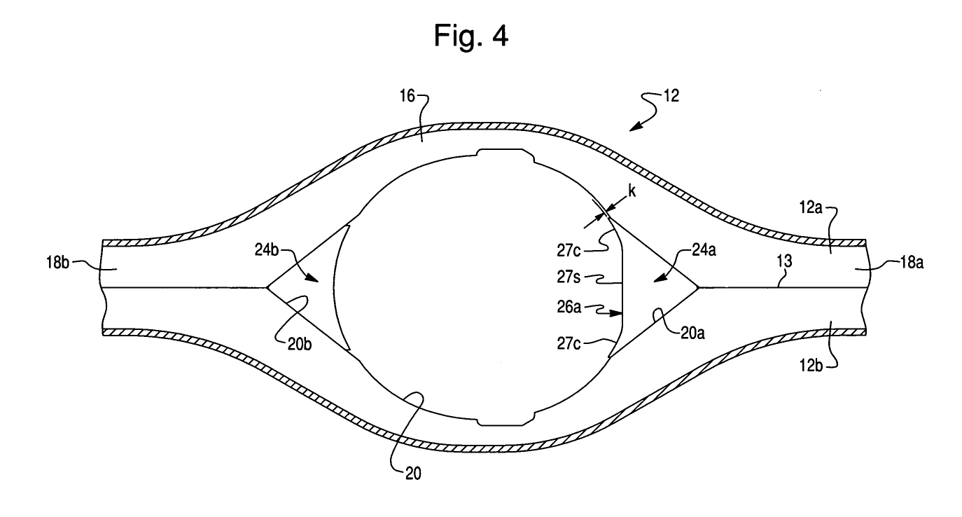

Moreover, first (left) and second (right) triangular-shaped, substantially flat rear web spacers 24a and 24b, respectively, are provided. The rear web spacers 24a and 24b are shaped generally in the configuration of the triangularly shaped side sections 20a and 20b of the rear opening 20. In other words, the web spacers 24a and 24b are incorporated into the split-formed axle housing 12 to reduce size of blanks used in fabrication of the split-formed banjo-type type axle housing. As illustrated in FIGS. 1-3, each of the web spacers 24a and 24b has opposite side surfaces 25 extending substantially in the direction of the central axis 11 of the axle housing 12. In other words, the web spacers 24a and 24b extend in a plane substantially along an outer wall 17 of the central section 16 of the axle housing 12. Thus, as best shown in FIG. 2, the rear web spacers 24a and 24b can be disposed within the side sections 20a and 20b so as to be flush with the adjacent the outer wall 17 of the central section 16. Moreover, the first rear web spacer 24a is provided with a substantially concave inner edge 26a defined by a curved line. Preferably, as illustrated in FIG. 4, the abutment edge 26a of the abutment member 24a includes a substantially straight central portion 27s and curved distal end portions 27c extending at an angle from the central portion 27s. The second rear web spacer 24b is provided with a concave inner edge 26b.

The rear web spacers 24a and 24b are finely secured, such as by welding as shown at 23 in FIGS. 2 and 3, to the central section 16 so as to completely close the triangularly shaped side sections 20a and 20b of the rear opening 20. As a result, only a generally oval or circular shaped portion of the rear central opening 20 remains to be covered. A rear cover 28 is secured to the central section 16 and to the rear web spacers 24a and 24b to close the rear opening 20 during operation, as shown in FIG. 3, and to protect the differential 40 and other components contained in the axle housing 12.

Similarly, as shown in FIG. 1, a pair of triangular-shaped front web spacers 30a and 30b is provided for the axle housing 12. The front web spacers 30a, 30b are shaped generally in the configuration of the triangularly shaped side sections 22a and 22b of the front central opening 22. Thus, the front web spacers 30a, 30b can be disposed within the sections 22a and 22b so as to be flush with the adjacent outer front surfaces of the central section 16. The front web spacers 30 then are secured, such as by welding as shown at 31 in FIGS. 2 and 3, to the central section 16 so as to completely close the triangularly shaped side sections 22a and 22b of the front opening 22. As a result, only a generally oval or circular shaped portion of the front central opening 22 remains to be covered. A substantially annular front mounting ring 32 is secured to the central section 16 and to the front web spacers 30a, 30b about the front opening 22.

As described above, the axle assembly 10 further includes the carrier 14 which is adapted to enclose and rotatably support the differential 40 therein. The carrier 14 includes a mounting flange 46 having a plurality of mounting bolt holes 47 formed therethrough. As will be explained below, the mounting flange 46 and the mounting bolt holes 47 are provided to secure the carrier 14 to the central section 16 of the axle housing 12 through the mounting ring 32. The mounting flange 46 defines a plane substantially parallel to the central axis 11. To rotatably support the differential 40 thereon, the carrier 14 is provided with outwardly extending first (left) and second (right) bearing supports 48a and 48b, respectively, outwardly extending from the mounting flange 46 of the carrier 14. In the illustrated embodiment of FIG. 1, each of the bearing supports 48a and 48b includes a pedestal member 50 formed integrally with the carrier 14, and a bearing cap 52 having an abutting surface 54 facing away from the differential case 42 in the direction of the central axis 11. The abutting surface 54 of the bearing cap 52 includes a substantially straight central portion 55s and curved distal end portions 55c. A semi-circular recess 51 is formed in a distal end of the pedestal member 50, while a complementary semi-circular recess 53 is formed in the bearing cap 52 for receiving the annular differential bearing 44a or 44b therein. These bearings 44a, 44b are provided for rotatably supporting the differential 40 within the carrier 14. The bearing caps 52 are respectively secured to the ends of the pedestal members 50 by threaded fasteners (not shown).

Those skilled in the art would appreciate that a gear separating force F_{S} (shown in FIGS. 2 and 3) is imparted to the differential case 42 in operation on the ring gear 43 by a drive pinion gear 45 (shown in FIG. 2) in a direction from the second differential bearing 44b to the first differential bearing 44a, i.e. substantially in the direction of the central axis 11. The first differential bearing 44a is commonly known in the art as a flange-side differential bearing, as the first differential bearing 44a is located adjacent to a flange of the differential case 42 to which the ring gear 43 is fastened (as shown in FIG. 3). The gear separating force F_{S} is transmitted as a bearing load to the bearing supports 48a and 48b through the differential case 42 and the differential bearings 44a, 44b. Those skilled in the art would further appreciate that the first (flange-side) bearing support 48a of the flange-side differential bearing 44a experiences in operation an especially large amount of the gear separating force that is resisted or constrained by the carrier 14 and the flange-side bearing support 48a. This gear separating force acts to deflect the flange-side bearing support 48a away from the pinion gear 45 and the carrier 14.

According to the first exemplary embodiment of the present invention, the first rear web spacer 24a that is located on the flange side of the differential 40 is also designed to restrain the deflection of the bearing cap 52 of the flange-side bearing support 48a during the operation of the differential 40. In other words, the first rear web spacer 24a also functions as an abutment member, or abutment plate. Specifically, the abutment member 24a is fastened to the axle housing 12 adjacent to the opening 20 so as to extend in a plane substantially parallel to the direction of the gear separating force F_{S} imparted in operation on the differential 40 and transmitted to the first bearing support 48a. In other words, the abutment member (abutment plate) 24a extends substantially in the direction of the central axis 11 of the axle housing 12. Moreover, the abutment member 24a slightly extends (intrudes) into the opening 20 to a distance k (as shown in FIG. 4) so that the inner (abutment) edge 26a of the abutment member 24a engages the bearing cap 52 of the flange-side bearing support 48a (as shown in FIG. 2).

In operation, the abutment member 24a engages the flange-side bearing support 48a and is axially compressed by the gear separating force F_{S} during the operation on the differential 40 in order to reduce or eliminate (restrain) deflection of the flange-side bearing support 48a relative to the axle housing 12 resulting from the action of the gear separating force F_{S} generated by operation of the differential 40. For this reason, the inner (abutment) edge 26a of the abutment member 24a is machined or stamped so as to be at least partially complementary to the abutting surface 54 of the bearing cap 52 of the flange-side bearing support 48a. Preferably, as illustrated in FIG. 3, an entire length of the abutment edge 26a of the abutment member 24a is complementary to the entire abutting surface 54 of the bearing cap 52 of the flange-side bearing support 48a. In other words, the central portion 27s of the abutment edge 26a is in contact to the central portion 55s of the abutting surface 54 of the bearing cap 52, while the curved distal end portions 27c of the abutment edge 26a are in contact with the corresponding curved distal end portions 55c of the abutting surface 54. Alternatively, only a portion of the abutment edge 26a of the abutment member 24a and only a portion of the abutting surface 54 of the bearing cap 52, which are ill contact with each other, are complementary. The first rear web spacer 24a therefore not only reduces material cost of the axle housing 12 by reducing the size of a blank, but also prevents the bearing cap of the flange-side bearing support from deflecting when under load. Furthermore, axle housing according to the first exemplary embodiment of the present invention is very cost effective as the only machining required to the interior of the banjo housing 12 with this invention is to the abutment edge 26a of the web spacer (abutment member) 24a.

The central openings 20, 22 and the front mounting ring 32 of the banjo housing 12 are sized to provide adequate clearance for the carrier 14 (even with the abutment member 24a intruding into the opening 22) between the banjo housing 12 and the differential bearing caps 52 such that the carrier 14 could be inserted in the central portion 16 of the axle housing 12 and axially move therewithin in the direction of the central axis 11 for position adjustment.

The method for assembling the drive axle assembly 10 according to the first exemplary embodiment of the present invention is as follows. First, the split-formed axle housing 12 having the openings 20 and 22 formed therethrough the central section 16 thereof and oriented substantially parallel to the central axis 11 is provided. Next, the substantially flat abutment member 24a, which also acts as the web spacer, is attached to the axle housing 12 adjacent to the opening 20 so as to extend substantially along the central axis 11 and slightly into the opening 20. The abutment edge 26a of the abutment member 24a is machined or stamped so at to be complementary to the abutting surface 54 of the bearing cap 52 of the flange-side bearing support 48a. Also, the carrier 14 including the bearing supports 48a, 48b rotatably supporting the differential 40 thereon is provided. Subsequently, the carrier 14 is inserted into the axle housing 12 through the opening 22. Preferably, the differential 40 is mounted to the carrier 14 before the carrier is inserted into the axle housing 12. The carrier 14 is assembled to the banjo housing 12 by inserting the carrier 14 into the second (front) central opening 22 of the axle housing 12 so that the differential bearing cap 52 is spaced in axial direction (in the direction of the central axis 11) from the abutment member 24a. Clearance between the web spacers 24a and 24b and the bearing supports 48a, 48b is necessary to assemble the carrier 14 into the axle housing 12. The carrier 14 is subsequently loosely secured to the central section 16 of the axle housing 12 through the mounting ring 32 by partially (not tightly) threading fasteners (not shown), such as bolts, through the plurality of the bolt holes 47 in the mounting flange 46 and mounting holes (not shown) in the mounting ring 32 to corresponding threaded bores (not shown) in the axle housing 12. Then, the carrier 14 is moved axially (laterally) along the central axis 11 of the axle housing 12 until the differential bearing cap 52 of the flange-side bearing support 48a is in physical contact (engages) with the abutment member 24a. Subsequently, the carrier 14 is firmly fastened in place (to the axle housing 12) by the threaded fasteners with the flange-side differential bearing cap 52 being supported by the axle housing 12 through the abutment member 24a.

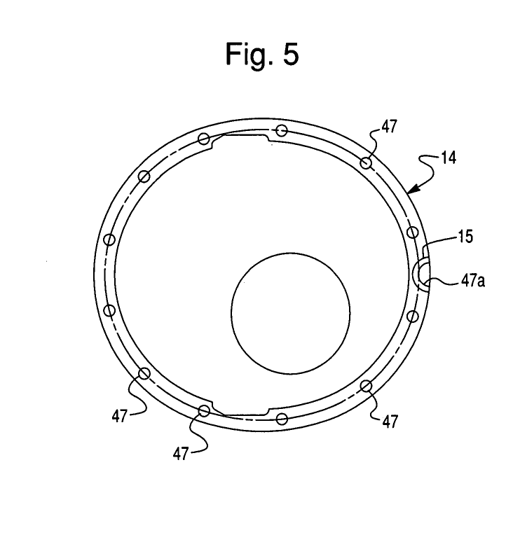

Preferably, as illustrated in FIGS. 2 and 5, the carrier 14 is formed with a boss 15 outwardly projecting from a front surface of the carrier 14. Further preferably, the boss 15 is cast in the carrier 14 with a semi-circular recess, or pocket, 47a machined therein. Moreover, the mounting bolt holes 47 in the mounting flange 46 are oversized, i.e. bigger in diameter than the fasteners used to secure the carrier 14 to the axle housing 12. This allows for limited movement of the carrier 14 on the face of (or relative to) the banjo housing 12 so that the flange-side differential bearing cap 52 can contact the abutment edge 26a of the abutment member 24a. It will be appreciated that the mounting bolt holes 47 may of any appropriate configuration, such as circular or oval.

According to the preferred embodiment of the present invention, the step of moving (sliding) the carrier 14 laterally along the central axis 11 is accomplished with the use of a power tool including a driving head 60 provided with a pin 62 complementary to the pocket 47a of the boss 15 of the carrier 14. In operation, after the carrier 14 is inserted into the axle housing 12 through the opening 22 and assembled thereto, the pin 62 of the driving head 60 is inserted and locked into the pocket 47a. Next, the driving head 60 presses the carrier 14 down toward the axle housing 12 while simultaneously sliding the carrier 14 over until the bearing cap 52 of the flange-side bearing support 48a contacts the abutment edge 26a of the abutment plate 24a. The carrier 14 is then firmly fastened to the banjo housing 12 while the carrier is pressed against the abutment plate 24a, resulting in t the flange-side differential bearing cap 52 having a positive stop. It will be appreciated that any method that would allow for an axial force to be applied to the carrier 14 relative to the housing 12 while the fasteners are being torqued down could be used.

Finally, the rear cover 28 is secured to the central section 16 and to the rear web spacers 24a and 24b to close the rear opening 20 during operation.

Therefore, the gear separating force in the drive axle assembly 10 is absorbed by contact between the flange-side bearing support 48a and the axle housing 12 through the abutment plate 24a which is axially compressed by the gear separating force imparted in operation on the differential 40 and transmitted to the flange-side bearing support 48a. Thus, the abutment plate 24a needs to be sized to accommodate the maximal value of the gear separating force F_{S} and to fill a gap between the opening 20 and the bearing cap 52 of the flange-side bearing support 48a. It will be appreciated that the abutment plate 24a may be manufactured by any appropriate method known in the art.

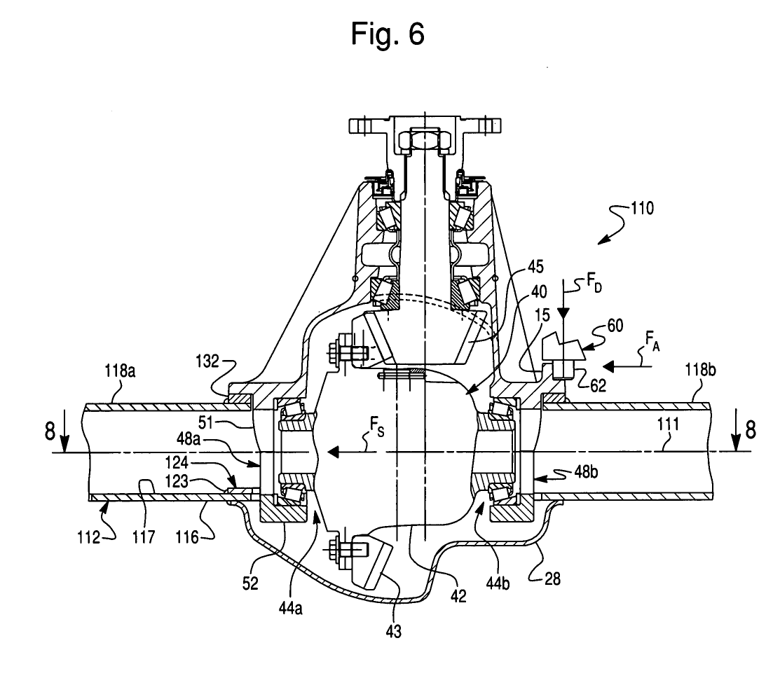

FIGS. 6-8 illustrate a drive axle assembly 110 according to a second exemplary embodiment of the present invention. Components, which are unchanged from the previous exemplary embodiments of the present invention, are labeled with the same reference characters. Components, which function in the same way as in the first exemplary embodiment of the present invention depicted in FIGS. 1-6 are designated by the same reference numerals to which 100 has been added, sometimes without being described in detail since similarities between the corresponding parts in the two embodiments will be readily perceived by the reader.

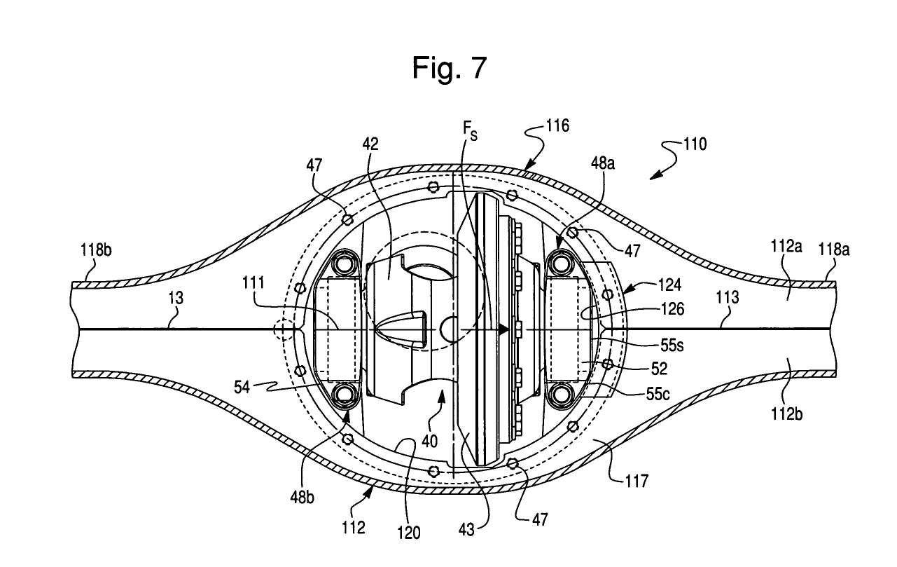

The drive axle assembly 110 according to the second exemplary embodiment of the present invention comprises a banjo-type axle housing 112, and a carrier 14 non-rotatably fastened to the axle housing 112 and rotatably supporting a differential case 42 of a conventional differential 40 through conventional first (left) and second (right) differential bearings 44a and 44b, respectively (shown in FIGS. 6 and 7). The banjo-type axle housing 112 comprises a hollow central section 116, and first (left) and second (right) hollow, elongated axle arm sections 118a and 118b, respectively, axially extending from the central section 116 in opposite directions along a central longitudinal axis 111 of the axle housing 112. The axle housing 112 can be formed by any conventional method known in the art, such as by welding two separately formed banjo housing half members 112a and 112b.

The central section 116 has a first (rear) central opening 120 formed therethrough on its rear side and a second (front) central opening 122 formed therethrough on its front side. Each of the central openings 120 and 122 defines a plane oriented substantially along (or parallel to) the central axis 111. However, by contrast to the axle housing 12 of the first exemplary embodiment of the present invention, the central section 116 of the axle housing 112 does not have triangularly shaped open side portions formed adjacent to the first and second axle arm sections 118a, 1118b, as illustrated in FIG. 7. As a result, the axle housing 112 does not incorporate the triangular-shaped web spacers, unlike the first exemplary embodiment of the present invention.

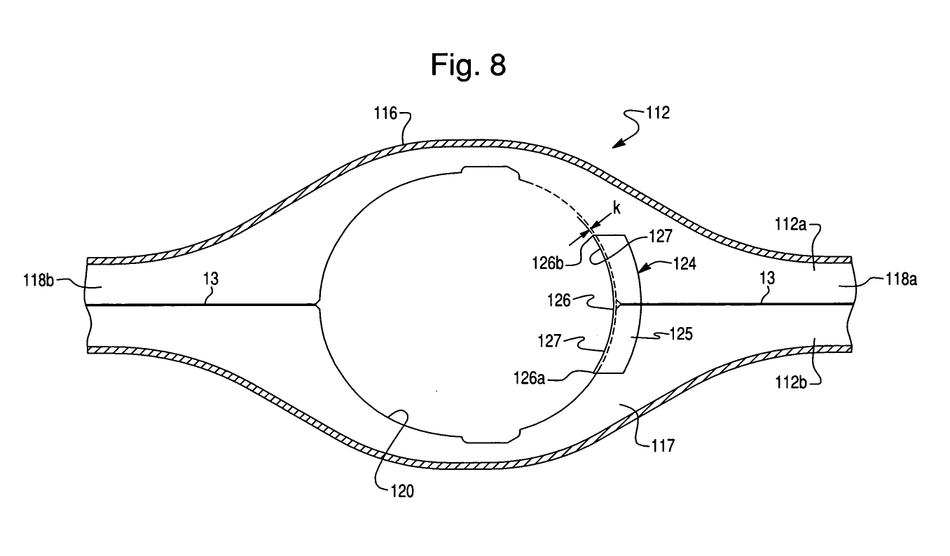

According to the second exemplary embodiment of the present invention, the axle assembly 110 further includes a separate, substantially flat abutment member incorporated in the axle housing 112 to provide support to the flange-side differential bearing support 48a. Preferably, the abutment member is in the form of a abutment plate 124 having opposite substantially flat side surfaces 125 and a substantially concave inner edge 126. Further preferably, the abutment plate 124 is in the form of a substantially annular segment defined as a portion of an annular ring “cut off” from the rest of the annular ring, as illustrated in FIGS. 7 and 8. Moreover, the side surfaces 125 of the abutment plate 124 have a constant width, and the concave inner edge 126 thereof is bounded by end points 126a and 126b (see FIG. 8).

The abutment plate 124 is firmly secured, such as by welding, to the axle housing 112, as shown at 123 in FIGS. 6 and 7. More specifically, the abutment plate 124 is fastened to an inner surface 117 of the central section 116 adjacent to the first central openings 120 therein so as to extend in a plane substantially parallel to the direction of the gear separating force F_{S} imparted in operation on the differential 40 and transmitted to the first bearing support 48a. In other words, the abutment plate 124 extends substantially in the direction of the central axis 11 of the axle housing 112. Moreover, the abutment plate 124 slightly extends (intrudes) into the opening 120 to a distance k (as shown in FIG. 8) so as to engage (in physical contact) the bearing cap 52 of the flange-side bearing support 48a (as shown in FIG. 7) in order to decrease deflection of the first bearing support 48a relative to the axle housing 112 resulting from the action of the gear separating force F_{S} generated by operation of the differential 40. For this reason, the inner edge 126 of the abutment plate 124 is machined or stamped so as to be at least partially complementary to the side surface 54 of the bearing cap 52 of the flange-side bearing support 48a. Preferably, as illustrated in FIG. 7, only distal end portions 127 (marked in FIG. 8) of the inner edge 126 of the abutment member 124 are complementary to the corresponding curved distal end portions 55c of the abutting surface 54 of the bearing cap 52. In other words, only the curved distal end portions 127 of the abutment edge 126 are in contact with the corresponding curved distal end portions 55c of the abutting surface 54. Alternatively, the inner edge 126 of the abutment plate 124 could be formed so that an entire length of the abutment edge 126 of the abutment member 124 is complementary to the abutting surface 54 of the bearing cap 52 of the flange-side bearing support 48a. Therefore, the gear separating force F_{S} is absorbed by contact between the flange-side bearing support 48a and the axle housing 112 through the abutment plate 124. Accordingly, the abutment plate 124 needs to be sized to accommodate the maximal value of the gear separating force and to fill a gap between the opening 120 and the flange-side bearing support 48a. It will be appreciated that the abutment plate 124 may be manufactured by any appropriate method known in the art.

The first abutment plate 124 therefore prevents the bearing cap of the flange-side bearing support from deflecting when under load. Furthermore, axle housing according to the second exemplary embodiment of the present invention is very cost effective as the only machining required to the interior of the banjo housing 112 with this invention is to the abutment edge 126 of the abutment plate 124.

The central openings 120, 122 and a front mounting ring 132 of the banjo housing 112 are sized to provide adequate clearance for the carrier 14 (even with the abutment member 124 intruding into the opening 122) between the banjo housing 112 and the differential bearing caps 52 such that the carrier 14 could be inserted in the central portion 116 of the axle housing 112 and axially move therewithin in the direction of the central axis 111 for positional adjustment.

The method for assembling the drive axle assembly 110 according to the second exemplary embodiment of the present invention is similar to one of the first exemplary embodiment, and is as follows. First, the axle housing 112 having the openings 120 and 122 formed therethrough the central section 116 thereof and oriented substantially parallel to the central axis 111 is provided. Next, the substantially flat abutment plate 124 is attached to the axle housing 112 adjacent to the opening 120 so as to extend substantially along the central axis 111 and slightly into the opening 120. The abutment edge 126 of the abutment plate 124 is machined so at to be complementary to the abutting side surfaces 54 of the bearing cap 52 of the flange-side bearing support 48a. Also, the carrier 14 including the bearing supports 48a, 48b rotatably supporting the differential 40 thereon is provided. Subsequently, the carrier 14 is inserted into the axle housing 112 through the opening 122. The carrier 14 is assembled to the banjo housing 112 and loosely secured thereto by partially (not tightly) threading fasteners (not shown), such as bolts, through the plurality of the mounting bolt holes 47 in the mounting flange 46 and mounting holes (not shown) in the mounting ring 132 to corresponding threaded bores (not shown) in the axle housing 112. Then, the carrier 14 is moved axially (laterally) along the central axis 111 of the axle housing 112 until the differential bearing cap 52 of the flange-side bearing support 48a is in physical contact (engages) with the abutment plate 124. Subsequently, the carrier 14 is firmly fastened in place (to the axle housing 112) by the threaded fasteners with the flange-side differential bearing cap 52 being supported by the axle housing 112 through the abutment member 124.

Therefore, the gear separating forces in the drive axle assembly 110 are absorbed by contact between the flange-side bearing support 48a and the axle housing 112 through the abutment plate 124. Thus, the abutment plate 124 needs to be sized to accommodate the maximal value of the gear separating force F_{S} and to fill a gap between the opening 120 and the bearing cap 52 of the flange-side bearing support 48a. It will be appreciated that the abutment plate 124 may be manufactured by any appropriate method known in the art.

Therefore, the present invention provides a novel abutment structure for a flange-side differential bearing support in the form of an abutment member attached to an axle housing and oriented in a direction of a gear separating force imparted in operation on the differential so as to engage the flange-side bearing support and absorb the gear separating force. Thus, the present invention minimizes or prevents deflections of the flange-side bearing support and, therefore, holds differential gears in proper positions, and extends the useful life and strength of the axle assembly. By integrating the abutment member with the axle housing, the present invention reduces cost, complexity and weight of the axle housing.

The foregoing description of the preferred embodiments of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

What is claimed is:

1. An axle assembly comprising:
an axle housing having a central axis and first and second openings formed through said axle housing opposite to each other;
a carrier including a differential bearing support supporting a differential thereon for rotation about said central axis, said carrier fastened to said axle housing adjacent to said second opening therein; and
an abutment member attached to said axle housing adjacent to said first opening to extend substantially in a direction of said central axis;
said abutment member engaging said differential bearing support and absorbing a gear separating force imparted in operation by said differential and transmitted to said differential bearing support in order to restrain deflection of said differential bearing support relative to said axle housing resulting from said gear separating force.

2. The axle assembly as defined in claim 1, wherein said abutment member has an inner edge engaging a side surface of said differential bearing support; at least a portion of said inner edge of said abutment member is complementary to said side surface of said differential bearing support.

3. The axle assembly as defined in claim 2, wherein an entire length of said inner edge of said abutment member is complementary to said side surface of said differential bearing support.

4. The axle assembly as defined in claim 1, wherein only distal end portions of said inner edge of said abutment plate are complementary to corresponding distal end portions of said side surface of the bearing cap.

5. The axle assembly as defined in claim 1, wherein said abutment member is in the form of a substantially flat plate.

6. The axle assembly as defined in claim 5, wherein said abutment member has substantially triangular shape having a substantially concave inner edge engaging said differential bearing support.

7. The axle assembly as defined in claim 6, wherein said first opening in said axle housing has a triangularly shaped open side portion;
wherein said triangular abutment member is formed generally in the configuration of said open side portion of said first opening; and
wherein said triangular abutment member is fastened to said axle housing so as to substantially close said open side section.

8. The axle assembly as defined in claim 5, wherein said abutment member is in the form of a substantially annular segment having a substantially concave inner edge engaging said differential bearing support.

9. The axle assembly as defined in claim 8, wherein said abutment member is fastened to an inner surface of said axle housing adjacent to said first openings thereof.

10. The axle assembly as defined in claim 1, wherein said abutment member extends into said first opening so as to engage said differential bearing support.

11. The axle assembly as defined in claim 1, wherein said differential bearing support includes a bearing cap provided at a distal end of said differential bearing support; and wherein said abutment member engages said bearing cap.

12. The axle assembly as defined in claim 1, wherein said differential bearing support includes two differential bearing supports; and wherein said abutment member engages only one of said differential bearing supports.

13. The axle assembly as defined in claim 1, wherein said carrier includes a plurality of oversized mounting holes formed therethrough; said plurality of oversized mounting holes are provided to secure said carrier to said axle housing and to allow limited movement of said carrier relative to said axle housing during mounting of said carrier to said axle housing so that said differential bearing support is able to engage said abutment member.

14. A method for assembling a drive axle assembly comprising the steps of:
providing an axle housing having a central axis and first and second openings formed through said axle housing opposite to each other;
attaching an abutment member to said axle housing adjacent to said first opening so as to extend substantially in a plane defined by said first opening;
providing a carrier including a differential bearing support supporting a differential thereon for rotation about said central axis;
inserting said carrier into said axle housing through said second opening;
moving said carrier laterally along said central axis until said differential bearing support being engaged with said abutment member.

15. The method as defined in claim 14, further including the step of fastening said carrier to said axle housing while said bearing support engages said abutment member.

16. The method as defined in claim 14, wherein said abutment member is in the form of a substantially flat plate.

17. The method as defined in claim 16, wherein said abutment member has substantially triangular shape having a substantially concave inner edge engaging said differential bearing support.

18. The method as defined in claim 17, wherein said first opening in said axle housing has a triangularly shaped open side portion;
wherein said triangular abutment member is formed generally in the configuration of said open side portion of said first opening; and
wherein the step of attaching an abutment member to said axle housing includes the step of fastening said triangular abutment member to said axle housing so as to substantially close said open side section.

19. The method as defined in claim 16, wherein said abutment member is in the form of a substantially annular segment having a substantially concave inner edge engaging said differential bearing support.

20. The method as defined in claim 19, wherein the step of attaching an abutment member to said axle housing includes the step of fastening said abutment member to an inner surface of said axle housing adjacent to said first openings thereof.

21. The method as defined in claim 14, wherein said abutment member extends into said first opening so as to engage said differential bearing support.

22. The method as defined in claim 14, wherein said differential bearing support includes a bearing cap provided at a distal end of said differential bearing support; and wherein said carrier is moved laterally along said central axis until said bearing cap of said differential bearing support engages an inner edge of said abutment member.

23. The method as defined in claim 14, wherein said abutment member has an inner edge engaging a side surface of said differential bearing support; at least a portion of said inner edge of said abutment member is complementary to said side surface of said differential bearing support.

24. The method as defined in claim 14, wherein said carrier has a recess therein; and
wherein the step of moving said carrier laterally along said central axis comprises the steps of:
providing a driving head having a pin complementary to said recess;
engaging said recess with said pin of said driving head;
pressing said carrier to said axle housing by displacing said driving head substantially perpendicularly to said central axis; and
displacing said driving head so as to move said carrier laterally along said central axis until said differential bearing support being engaged with said abutment member.

25. The method as defined in claim 24, wherein said carrier includes a boss provided on an outer surface thereof so that said recess is formed in said boss.

26. The method as defined in claim 14, wherein said carrier includes a plurality of oversized mounting holes formed therethrough; said plurality of oversized mounting holes are provided to secure said carrier to said axle housing and to allow limited movement of said carrier relative to said axle housing during the step of moving said carrier laterally along said central axis until said differential bearing support being engaged with said abutment member.
